(19) United States
(12) Patent Application Publication
(10) Pub. No.: US 2021/0033048 A1
(43) Pub. Date: Feb. 4, 2021

(54) Fuel Vapor Processing Apparatus

(71) Applicant: AISAN KOGYO KABUSHIKI KAISHA, Obu-shi (JP)

(72) Inventors: Masahiro KOBAYASHI, Obu-shi (JP); Masatoshi MORlYAMA, Obu-shi (JP)

(73) Assignee: AISAN KOGYO KABUSHIKI KAISHA, Obu-shi (JP)

(21) Appl. No.: 16/912,992

(22) Filed: Jun. 26, 2020

(30) Foreign Application Priority Data
Aug. 1, 2019 (JP) 2019-142187

(51) Int. Cl. F02M 25/08; B01D 53/04

(52) U.S. Cl. CPC F02M 25/0854; B01D 53/0415; B01D 2253/102; B01D 2259/4516; B01D 2259/40086

(57) ABSTRACT

A fuel vapor processing apparatus includes a case having a passage. In addition, the case has a tank port and a purge port in fluid communication with one end of the passage. Further, the case includes an atmosphere port in fluid communication with another end of the passage. The passage has a first layering and a second layering filled with an adsorbent and arranged in series. The first layering includes an upper adsorption layer, a middle adsorption layer, and a lower adsorption layer arranged in series. The upper adsorption layer and the lower adsorption layer are filled with a first adsorbent. The middle adsorption layer is filled with a second adsorbent. The ventilation resistance of the middle adsorption layer due to the second adsorbent is greater than the ventilation resistance of the upper adsorption layer and the lower adsorption layer due to the first adsorbent.

### CROSS-REFERENCE TO RELATED APPLICATIONS

This application claims priority to Japanese patent application serial number 2019-142187, filed Aug. 1, 2019, which is hereby incorporated herein by reference in its entirety for all purposes.

### BACKGROUND

Embodiments of the present disclosure relate to fuel vapor processing apparatus. More particularly, the embodiments relate to fuel vapor processing apparatus to adsorb and desorb fuel vapors generated in a fuel tank of a vehicle of a car, or the like.

Some fuel vapor processing apparatus may include a case having a passage through which gas flows. The case has a tank port communicating with one end of the passage and an atmosphere port communicating with the other end of the passage. The passage comprises a first layering on the side with the tank port and a second layering on the side with the atmosphere port. Each layering is filled with an adsorbent that adsorbs fuel vapor. The first layering and the second layering are disposed in series along the passage. The first layering is entirely filled with an activated carbon as the adsorbent.

### SUMMARY

In accordance with an aspect of the present disclosure, a fuel vapor processing apparatus may comprise a case including a passage through which gas flows. The case may include a tank port communicating with one end of the passage and an atmosphere port communicating with the other end of the passage. The passage may have a first layering on the side of the tank port and a second layering on the side of the atmosphere port. The first layering and the second layering may be filled with an adsorbent that adsorbs a fuel vapor. The first layering and the second layering may be disposed in series. The first layering may include at least a first adsorption layer, a second adsorption layer, and a third adsorption layer. The second adsorption layer may be arranged between the first adsorption layer and the third adsorption layer. The first adsorption layer and the third adsorption layer may be filled with a first adsorbent. The second adsorption layer may be filled with a second adsorbent. A ventilation resistance of the second adsorption layer due to the second adsorbent may be larger than that of the first adsorption layer and the third adsorption layer due to the first adsorbent.

When the fuel vapor processing apparatus adsorbs the fuel vapor, the fuel vapor may flow into the first adsorption layer, located on the upstream side of the first layering. When the fuel vapor passes through the second adsorption layer, the fuel vapor may be easily dispersed over the entire passage cross-section of the second adsorption layer. Therefore, the fuel vapor may be evenly distributed to the third adsorption layer on the downstream side. As a result, the adsorption performance of the fuel vapor in the third adsorption layer is improved. The fuel vapor may be also adsorbed due to the second adsorbent of the second adsorption layer. Therefore, the adsorbed amount of the fuel vapor in the first layering can be increased. Thus, due to the synergistic effect of improving the adsorption performance of the fuel vapor in the third adsorption layer and increasing amount of adsorbed fuel vapor in the first layering, the adsorption performance of the fuel vapor in the entire first layering is improved.

In accordance with another aspect of the present disclosure, the first adsorbent may be a granulated activated carbon. The particle size of the granulated activated carbon as the first adsorbent may be larger than that of a crushed activated carbon. Therefore, the ventilation resistance of the first adsorption layer and the third adsorption layer due to the first adsorbent can be reduced. The granulated activated used in a general fuel vapor processing apparatus may be used. The particle size of the activated carbon may be, for example, the volume-converted average particle size of the activated carbon.

In accordance with another aspect of the present disclosure, the second adsorbent may be the crushed activated carbon. The particle size of the crushed activated carbon as the second adsorbent may be smaller than that of the granulated activated carbon. Therefore, the ventilation resistance of the second adsorption layer due to the second adsorbent is larger. The adsorption performance of the crushed activated carbon is smaller than that of the granulated activated carbon. Therefore, the heat of condensation due to the adsorption of the fuel vapor is reduced. As a result, it is possible to suppress an increase in temperature of the central portion of the first layering and improve the adsorption performance of the fuel vapor of the first layering. A crushed activated carbon used in a general fuel vapor processing apparatus may be used.

In accordance with another aspect of the present disclosure, the first adsorption layer may be disposed adjacent to the tank port. Therefore, a fuel vapor containing gas from the tank port can be promptly introduced into such first adsorption layer.

In accordance with another aspect of the present disclosure, a space layer may be provided between the first adsorption layer and the tank port. Therefore, the fuel vapor containing gas introduced from the tank port to the first adsorption layer can be preliminarily homogenized in the space layer.

### BRIEF DESCRIPTION OF THE DRAWINGS

FIG. 1 is a cross-sectional view of an embodiment of a fuel vapor processing apparatus in accordance with the principles described herein.

### DETAILED DESCRIPTION

As previously described, some fuel vapor processing apparatus include a case having a passage through which gas flows, a tank port communicating with one end of the passage, and an atmosphere port communicating with the other end of the passage. The passage comprises a first layering on the side with the tank port and a second layering on the side with the atmosphere port, each layering being filled with an adsorbent that adsorbs fuel vapor. Often, a granulated activated carbon, which has a larger particle size than a crushed activated carbon, is used as the adsorbent for the first layering disposed on the side of the tank port. Consequently, the granulated activated carbon of the first layering provides a relatively low resistance to the flow of fuel vapors. Thus, for example, the fuel vapor, such as gasoline vapor, that enters from the tank port during the adsorption process (during the charging operation) tends not to spread laterally across the entire first layering. Therefore, a large amount of the fuel vapor is adsorbed in the central portion of the first layering, which defines the main passage of the fuel vapor. As a result, a lot of heat is generated, due to condensation, at the central portion of the first layering, thereby reducing the adsorption performance of the fuel vapor of the first layering. Further, the granulated activated carbon in the portions distal to the central portion of the first layering (especially the portions of the granulated activated carbon on the wall side of the first layering) are not effectively used. As a result, the fuel vapor adsorption performance of the first layering is low.

Therefore, there is a need for a fuel vapor processing apparatus having a first layering on the side of the tank port and a second layering on the side of the atmosphere port that have improved fuel vapor adsorption performance across the entire first layering.

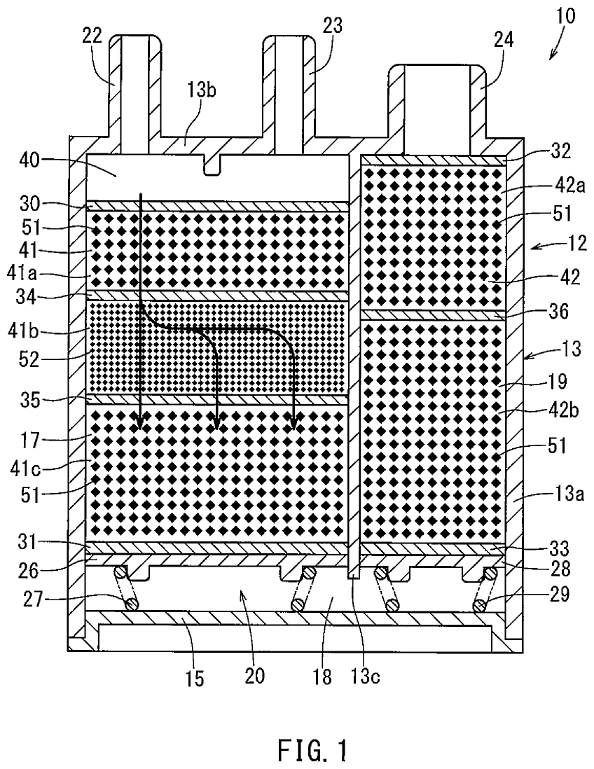

A representative embodiment of the present disclosure will be described with reference to FIG. 1. A fuel vapor processing apparatus of the embodiment may be a canister mounted on a vehicle, such as an automobile. The mounting direction of the fuel vapor processing apparatus is not limited to the direction shown in the FIG. 1.

As illustrated in FIG. 1, a fuel vapor processing apparatus 10 includes an outer case 12 formed in substantially a rectangular box shape. The case 12 may be made of, for example, resin. The case 12 includes a case body 13 and a lid member 15. The case body 13 may have a rectangular prismatic geometry with a bottom or lower end that is open and a top or upper end that is closed. The lid member 15 may have substantially flat plate-like geometry. The opened lower end of the case body 13 is closed by the lid member 15. The case body 13 includes a rectangular tubular portion 13a and an upper end wall portion 13b. The tubular portion 13a may have a rectangular prismatic geometry. The upper end of the case body 13 may be closed by the end wall portion 13b.

As illustrated in FIG. 1, the inside of the case body 13 is divided by a partition wall 13c into a main space portion 17 (left side in FIG. 1) and an auxiliary space portion 19 (right side in FIG. 1). A communication space portion 18 is formed between the case body 13 and the lid member 15. The main space portion 17 and the auxiliary space portion 19 are in fluid communication with each other via the communication space portion 18. As a result, a passage 20, which is defined by the main space portion 17, the communication space portion 18, and the auxiliary space portion 19, has generally a U shape geometry. The gas flows through the passage 20.

A tank port 22 and a purge port 23, both of which provide fluid communication between the main space portion 17 and the outside, are formed on the end wall portion 13b of the case body 13. The tank port 22 and the purge port 23 both communicate with one end side of the passage 20. The tank port 22 is in fluid communication with the air layer portion of the fuel tank (not shown). The purge port 23 is in fluid communication with the intake passage of the engine (not shown). Further, an atmosphere port 24, which provides fluid communication between the auxiliary space portion 19 and the outside, is also formed on the end wall portion 13b. Thus, the atmosphere port 24 is in fluid communication with the other end of the passage 20 opposite the tank port 22 and the purge port 23. The atmosphere port 24 may communicate with the atmosphere. In this embodiment, the main space portion 17 is a portion on the side of the tank port 22, and the auxiliary space portion 19 is a portion on the side of the atmosphere port 24.

A space layer filter 30, which may be sheet-shaped, is disposed on the upper part of the main space portion 17 so as to be near or covering the tank port 22 and the purge port 23. A first perforated plate 26, having air permeability, is disposed at the lower end opening of the main space portion 17. The perforated plate 26 may be made of, for example, resin. A first perforated plate filter 31, which may be sheet-shaped, is disposed on the upper surface of the first perforated plate 26 so as to be near or covering it in a layered fashion. A first spring member 27 is disposed between the first perforated plate 26 and the lid member 15. The first spring member 27 may be a coil spring. The first spring member 27 biases the first perforated plate 26 upward. In this way, a first layering 41 positioned between the space layer filter 30 and the first perforated plate filter 31 is provided in the main space 17.

The space layer filter 30 may be disposed at a predetermined distance from the end wall portion 13b of the case body 13, thereby defining a space layer 40 between the end wall portion 13b and the space layer filter 30.

An atmosphere filter 32, which may generally be sheet-shaped, is disposed on the upper end of the auxiliary space portion 19 so as to be near or covering the atmosphere port 24. A second perforated plate 28, having air permeability, is disposed at the lower end opening of the auxiliary space portion 19. The second perforated plate 28 may be made of, for example, resin. A second perforated plate filter 33, which may generally be sheet-shaped, is disposed on the upper surface of the second perforated plate 28 so as to be near or covering the second perforated plate 28 in a layered fashion. A second spring member 29 is positioned between the second perforated plate 28 and the lid member 15. The second spring member 29 may be a coil spring. The second spring member 29 biases the second perforated plate 28 upward. In this way, a second layering 42 positioned between the atmosphere filter 32 and the second perforated plate filter 33 is provided in the auxiliary space portion 19. The first layering 41, which is on the side of the tank port 22, and the second layering 42, which is on the side of the atmosphere port 24, are disposed in series. The first layering 41 may have a larger capacity than the second layering 42.

The first layering 41 may be divided into three sub-layers by a first layer filter 34 and a second layer filter 35. A first upper adsorption sub-layer 41a is formed between the space layer filter 30 and the first layer filter 34. The first upper adsorption sub-layer 41a is disposed proximal the space layer 40 and the tank port 22. A middle adsorption sub-layer 41b is formed between the first layer filter 34 and the second layer filter 35. A first lower adsorption sub-layer 41c is formed between the second layer filter 35 and the first perforated plate filter 31. The first upper adsorption sub-layer 41a (which is an embodiment of the “first adsorption layer”), the middle adsorption sub-layer 41b (which is an embodiment of the “second adsorption layer”), and the first lower adsorption sub-layer 41c (which is an embodiment of the “third adsorption layer”) are disposed in series as shown in FIG. 1.

The second layering 42 may be divided into two sub-layers by a third layer filter 36. A second upper adsorption sub-layer 42a is formed between the atmosphere filter 32 and the third layer filter 36. A second lower adsorption sub-layer 42b is formed between the third layer filter 36 and the second perforated plate filter 33.

The first upper adsorption sub-layer 41a, the middle adsorption sub-layer 41b, the first lower adsorption sub-layer 41c, the communication space portion 18, the second lower adsorption sub-layer 42b, and the second upper adsorption sub-layer 42a are arranged in series relative to the flow of the fuel vapor containing gas, which consists of the air containing the fuel vapor, during the adsorption. That is, during the adsorption, the side of the tank port 22 becomes the upstream side of the gas flow, and the side of the atmosphere port 24 becomes the downstream side of the gas flow. Each of the filters 30-36 may be made of a resin non-woven fabric, urethane foam, or the like.

The first upper adsorption sub-layer 41a, the first lower adsorption sub-layer 41c, the second upper adsorption sub-layer 42a, and the second lower adsorption sub-layer 42b are filled with a first adsorbent 51. The first adsorbent 51 is configured to adsorb and desorb fuel vapor. A granulated activated carbon may be used as the first adsorbent 51. The granulated activated carbon may be activated carbon obtained by molding a powdered activated carbon into particles with a binder.

The middle adsorption sub-layer 41b of the first layering 41 is filled with a second adsorbent 52. The second adsorbent 52 is configured to adsorb and desorb fuel vapor. A crushed activated carbon may be used as the second adsorbent 52. The average particle size of the crushed activated carbon used as the second adsorbent 52 is smaller than the average particle size of the granulated activated carbon used as the first adsorbent 51. For example, when the average particle size of the first adsorbent 51 is 3 to 7 mm, the average particle size of the second adsorbent 51 may be 2 ± 0.5 mm.

The operation of the fuel vapor processing apparatus 10 during adsorption of the fuel vapor containing gas will be described. When a vehicle engine (not shown) is stopped or the like, a fuel vapor containing gas may be generated. Such fuel vapor containing gas is introduced into the first layering 41, via the tank port 22 and the space layer 40. The fuel vapor is adsorbed by the first adsorbent 51 and the second adsorbent 52 while the fuel vapor containing gas flows through the first upper adsorption sub-layer 41a, the middle adsorption sub-layer 41b, and the first lower adsorption sub-layer 41c.

At this time, the fuel vapor containing gas introduced from the tank port 22 to the first upper adsorption sub-layer 41a of the first layering 41 is preliminarily homogenized in the space layer 40. In the first layering 41, the crushed activated carbon acting as the second adsorbent 52 of the middle adsorption sub-layer 41b has a particle size smaller than that of the granulated activated carbon acting as the first adsorbent 51 of the first upper adsorption sub-layer 41a and the first lower adsorption sub-layer 41c. Therefore, the ventilation resistance of the middle adsorption sub-layer 41b due to the second adsorbent 52 is larger than ventilation resistance of the upper adsorption sub-layer 41a and the lower adsorption sub-layer 41c due to the first adsorbent 51. Thus, when the fuel vapor coming from the space layer 40 passes through the middle adsorption sub-layer 41b, the fuel vapor is generally dispersed over the entire passage cross-section of the middle adsorption sub-layer 41b. As a result, the fuel vapor is substantially evenly distributed to the lower adsorption sub-layer 41c (e.g., see the split arrow in FIG. 1). The crushed activated carbon of the middle adsorption sub-layer 41b may have lower adsorption performance than the granulated activated carbon of the upper adsorption sub-layer 41a and the lower adsorption sub-layer 41c. Therefore, the heat of condensation due to the adsorption of the fuel vapor by the first layering 41 is reduced. As a result, an increase in the temperature of the central portion of the first layering 41 is suppressed.

The fuel vapor in fuel vapor containing gas that is not adsorbed by the first layering 41 is introduced into the second layering 42 via the communication space portion 18. While the fuel vapor containing gas flows through the second lower adsorption sub-layer 42b and the second upper adsorption sub-layer 42a of the second layering 42, the remaining fuel vapor is adsorbed by the first adsorbent 51. After that, air containing almost no fuel vapor may be released from the atmosphere port 24 into the atmosphere.

The operation of the fuel vapor processing apparatus 10 during purging of the fuel vapor will now be described. When the condition for performing the purge process is satisfied during the operation of the engine, the intake negative pressure of the engine is applied to the passage 20 within the case 12, via the purge port 23. Accordingly, gas (e.g., air) from the atmosphere is introduced from the atmosphere port 24 and into the second layering 42 as a purge gas. The purge gas desorbs the fuel vapor from the first adsorbent 51 in the second upper adsorption sub-layer 42a and the second lower adsorption sub-layer 42b of the second layering 42. The purge gas passes through the communication space portion 18. Then, the purge gas desorbs the first fuel vapor from the first adsorbent 51 and the second adsorbent 52 in the first lower adsorption sub-layer 41c, the middle adsorption sub-layer 41b, and the first upper adsorption sub-layer 41a of the first layering 41. The purge gas then passes to the engine via the space layer 40 and the purge port 23. The desorbed fuel vapor in the purge gas may be burned in the engine. As described above, during the purge process, the side of the atmosphere port 24 becomes the upstream side of the gas flow, and the side of the purge port 23 becomes the downstream side of the gas flow.

As described above, the fuel vapor processing apparatus 10 has a first layering 41 on the side of the tank port 22 and a second layering 42 on the side of the atmosphere port 24. The middle adsorption sub-layer 41b between the first upper adsorption sub-layer 41a and the first lower adsorption sub-layer 41c of the first layering 41 are filled with the second adsorbent 52. The first upper adsorption sub-layer 41a and the first lower adsorption sub-layer 41c are filled with the first adsorbent 51. The ventilation resistance of the second adsorbent 52 is larger than that of the first adsorbent 51.

When the fuel vapor is to be adsorbed, the fuel vapor flows into the middle adsorption sub-layer 41b of the first layering 41 from the first upper adsorption sub-layer 41a of the first layering 41. At this time, the fuel vapor is easily dispersed over the entire passage cross-section of the middle adsorption sub-layer 41b. Therefore, the fuel vapor flow is evenly distributed as it flows into the lower adsorption sub-layer 41c. As a result, the adsorption performance of the fuel vapor in the lower adsorption sub-layer 41c is improved. The fuel vapor is also adsorbed by the second adsorbent 52 of the middle adsorption sub-layer 41b. Therefore, the adsorbed amount of the fuel vapor in the first layering 41 may be increased. Thus, due to the synergistic effect of improving the fuel vapor adsorption performance of the first lower adsorption sub-layer 41c and increasing amount of fuel vapor adsorbed by the first layering 41, the fuel vapor adsorption performance of the entire first layering 41 is improved.

Based on previous designs, in order to improve the fuel vapor adsorption performance of a layer corresponding to the first layering, it was necessary to increase the capacity of the first layering so as to increase the amount of adsorbent contained therein, which necessitated a larger case. On the other hand, according embodiments described herein, it is possible to avoid increasing the size of the case 12, thereby allowing the case to easily mount on a vehicle or the like.

The first adsorbent 51 in the first upper adsorption sub-layer 41a and the first lower adsorption sub-layer 41c of the first layering 41 may be granulated activated carbon. Since the particle size of granulated activated carbon is larger than that of crushed activated carbon, the ventilation resistance of the first upper adsorption sub-layer 41a and the first lower adsorption sub-layer 41c due to the first adsorbent 51 may be relatively reduced.

The second adsorbent 52 in the middle adsorption sub-layer 41b of the first layering 41 may be crushed activated carbon. Since the particle size of crushed activated carbon is smaller than that of granulated activated carbon, the ventilation resistance of the middle adsorption sub-layer 41b due to the second adsorbent 52 is relatively larger. The crushed activated carbon has lower adsorption performance than the granulated activated carbon. Therefore, the heat of condensation due to the adsorption of the fuel vapor is reduced. As a result, it is possible to suppress an increase in the temperature of the central portion of the first layering 41 and improve the adsorption performance of the fuel vapor by the first layering 41.

The upper adsorption sub-layer 41a is disposed in the immediate vicinity of the tank port 22. Therefore, the fuel vapor gas from the tank port 22 is promptly introduced into the upper adsorption sub-layer 41a.

A space layer 40 is provided between the upper adsorption sub-layer 41a of the first layering 41 and the tank port 22. Therefore, the fuel vapor containing gas introduced from the tank port 22 to the upper adsorption sub-layer 41a is preliminarily homogenized in the space layer 40.

The embodiments disclosed in regard to the present disclosure are not limited to the above-described embodiment, and can be implemented in various other forms. For example, the embodiments disclosed in the present disclosure are not limited to a fuel vapor processing apparatus for vehicles, but may be applied to a fuel vapor processing apparatus for ships, industrial machines, or the like. Further, the shape of the passage 20 is not limited to a U-shape, but may be an I-shape, or may be implemented as any other appropriate shape. The fuel vapor processing apparatus 10 may have a tank port 22 and an atmosphere port 24. Instead of this configuration, the fuel vapor processing apparatus 10 may have a single port that serves as both of the tank port 22 and the purge port 23. Further, the space layer 40 may be omitted from the fuel vapor processing apparatus 10. Still further, the configuration of the adsorption layer of the second layering 42, the adsorbent to be used, and/or the like may be changed as appropriate.

The example described in detail above, with reference to the attached drawing, is intended to be representative of the present disclosure and is thus a non-limiting embodiment. The detailed description is intended to teach a person of skill in the art to make, use, and/or practice various aspects of the present teachings, and thus does not limit the scope of the disclosure in any manner. Furthermore, each of the additional features and teachings disclosed above may be applied and/or used separately or with other features and teachings in any combination thereof, so as to provide an improved fuel vapor processing apparatus, and/or methods of making and using the same.

What is claimed is:

1. A fuel vapor processing apparatus, comprising:
a case including a passage through which gas flows;
a tank port formed on the case, the tank port in fluid communication with a first end of the passage;
an atmosphere port formed on the case, the atmosphere port in fluid communication with a second end of the passage;
a first layering disposed in the passage at a position nearer the tank port than the atmosphere port; and
a second layering disposed in series with the first layering and disposed in the passage at a position nearer the atmosphere port than the tank port;
wherein:
the first layering includes a first adsorption layer, a second adsorption layer, and a third adsorption layer arranged in series;
the first adsorption layer and the third adsorption layer are filled with a first adsorbent;
the second adsorption layer is filled with a second adsorbent; and
a ventilation resistance of the second adsorption layer due to the second adsorbent is larger than a ventilation resistance of the first adsorption layer and the third adsorption layer due to the first adsorbent.

2. The fuel vapor processing apparatus according to claim 1, wherein the first adsorbent is a granulated activated carbon.

3. The fuel vapor processing apparatus according to claim 1, wherein the second adsorbent is a crushed activated carbon.

4. The fuel vapor processing apparatus according to claim 1, wherein the first adsorption layer is disposed adjacent to the tank port.

5. The fuel vapor processing apparatus according to claim 1, wherein a space layer is positioned between the first adsorption layer and the tank port.

6. The fuel vapor processing apparatus according to claim 1, wherein the first adsorbent has an average particle size that is larger than an average particle size of the second adsorbent.

7. The fuel vapor processing apparatus according to claim 1, wherein the first adsorption layer has a density that is less than a density of the second adsorption layer.

8. The fuel vapor processing apparatus according to claim 1, wherein the first adsorbent has a fuel vapor adsorption rate greater than a fuel vapor adsorption rate of the second adsorbent.

9. A fuel vapor processing apparatus, comprising:
a case including a passage through which gas flows;
a tank port formed on the case, the tank port in fluid communication with a first end of the passage;
an atmosphere port formed on the case, the atmosphere port in fluid communication with a second end of the passage;
a first adsorption layer disposed in the passage at a position nearer the tank port than the atmosphere port;
a third adsorption layer disposed in the passage at a position nearer the atmosphere port than the tank port; and
a second adsorption layer disposed in the passage at a position between the first adsorption layer and the third adsorption layer, wherein:
a ventilation resistance of the second adsorption layer is larger than a ventilation resistance of the first adsorption layer, a ventilation resistance of the third adsorption layer, or a ventilation resistance of both the first adsorption layer and the third adsorption layer.

10. The fuel vapor processing apparatus according to claim 9, wherein a first adsorbent in the first adsorption layer has an average particle size that is greater than an average particle size of a second adsorbent in the second adsorption layer.

11. The fuel vapor processing apparatus according to claim 9, wherein a first adsorbent in the third adsorption layer has an average larger particle size that is greater than an average particle size of a second adsorbent in the second adsorption layer.

12. The fuel vapor processing apparatus according to claim 9, wherein the first adsorption layer has a density lower than a density of the second adsorption layer.

13. The fuel vapor processing apparatus according to claim 9, wherein the third adsorption layer has a density lower than a density of the second adsorption layer.

14. The fuel vapor processing apparatus according to claim 9, wherein the first adsorption layer has a density substantially the same as a density of the third adsorption layer.

15. The fuel vapor processing apparatus according to claim 9, wherein the second adsorption layer has a fuel vapor adsorption rate that is less than a fuel vapor adsorption rate of the first adsorption layer, a fuel vapor adsorption rate of the third adsorption layer, or a fuel vapor adsorption rate of both the first adsorption layer and the third adsorption layer.

16. The fuel vapor processing apparatus according to claim 9, further comprising a space layer between the first adsorption layer and the tank port.

17. The fuel vapor processing apparatus according to claim 9, wherein the first adsorption layer has a height that is less than a height of the second adsorption layer.

18. The fuel vapor processing apparatus according to claim 9, wherein the second adsorption layer has a height that is less than a height of the third adsorption layer.

19. The fuel vapor processing apparatus according to claim 9, wherein the first adsorption layer has a height that is less than a height of the third adsorption layer.

20. A fuel vapor processing apparatus, comprising:
a case including a passage through which gas flows;
a tank port formed on the case, the tank port in fluid communication with a first end of the passage;
an atmosphere port formed on the case, the atmosphere port in fluid communication with a second end of the passage;
a first adsorption layer disposed in the passage at a position nearer the tank port than the atmosphere port;
a third adsorption layer disposed in the passage at a position nearer the atmosphere port than the tank port;
a second adsorption layer disposed in the passage at a position between the first adsorption layer and the third adsorption layer;
a first adsorbent in the first adsorption layer, the third adsorption layer, or both the first adsorption layer and the second adsorption layer; and
a second adsorbent in the second adsorption layer, wherein:
the first adsorbent has an average particle size that is greater than an average particle size of the second adsorbent.
